(19) United States
(12) Patent Application Publication
(10) Pub. No.: US 2025/0201453 A1
(43) Pub. Date: Jun. 19, 2025

(54) BUSHING CONNECTOR COVER FOR HIGH VOLTAGE EQUIPMENT

(71) Applicant: ECO ELECTRICAL SYSTEMS, INC, Reno, NV (US)

(72) Inventor: Michael Lynch, Reno, NV (US)

(73) Assignee: ECO ELECTRICAL SYSTEMS, INC, Reno, NV (US)

(21) Appl. No.: 18/945,337

(22) Filed: Nov. 12, 2024

Related U.S. Application Data
(60) Provisional application No. 63/612,301, filed on Dec. 19, 2023.

(51) Int. Cl. H01B 17/38

(52) U.S. Cl. CPC H01B 17/38

(57) ABSTRACT

A dielectric bushing connector cover, for use with high voltage components, has a dielectric inner connector cover that securely fits over an energized metal connector of the bushing. The inner connector cover has an opening for receiving an energized wire. Over the inner connector cover is a dielectric outer barrier. The outer barrier is securely supported by the top skirts of the ceramic bushing. The bushing may be supported by a grounded housing of a transformer. Since the metal connector is surrounded by at least two dielectric layers and an air gap, there is no voltage arc or leakage current between a bird's nest contacting the outer barrier and the transformer housing. In another embodiment, the outer barrier may surround a conventional plastic bushing cover without directly contacting the conventional bushing cover.

### CROSS-REFERENCE TO RELATED APPLICATIONS

This application claims priority to provisional application Ser. No. 63/612,301, filed on Dec. 19, 2023, by Michael Lynch.

### FIELD OF THE INVENTION

The invention relates to a dielectric bushing cover for high voltage components, especially for high voltage components such as transformers that may support a bird's nest or other temporary structure that may come in contact with the bushing cover.

### BACKGROUND

In the field of high voltage equipment, such as for use with 12 KV or more, it is sometimes important that energized metal parts be protected by a dielectric cover to prevent animals, such as birds and squirrels, from creating a short between the energized metal and a grounded structure or a short between two phases.

FIG. 1 illustrates a top portion of a conventional ceramic bushing 10 that has a hole extending through its length. The bushing's skirts 11 prevent water from forming a continuous path between the top and bottom of the bushing 10. The top end of the bushing 10 has a metal connector 12 (e.g., a clamp) that receives a high voltage conductor (a wire), where a screw 14 is tightened to clamp the connector 12 onto the wire. Another conductor extends from the connector 12, through the center axis of the bushing 10, and to another electrical connector at the bottom of the bushing 10 for connection to, for example, a transformer. The bottom portion 15 of the metal connector 12 is circular. The bushing 10 usually has a metal support structure near its bottom end that is bolted to a transformer's grounded housing for supporting the bushing 10. Such bushings 10 may be used with any high voltage equipment, such as reclosers, capacitors, regulators, etc.

In the examples given below, it is assumed that the bushing 10 extends from a grounded transformer housing, where a bird may build a nest on the top of the transformer housing. The nest's twigs may contact the bushing.

FIG. 2 illustrates a transformer 16, having a grounded housing 18 containing a transformer, such as for converting 12 KV to a household voltage. Two bushings 10 are shown attached to the top of the transformer 16.

FIG. 3 illustrates a prior art, one-piece plastic (or other polymer) cover 20 over a transformer bushing's metal connector for preventing direct contact between wildlife and the energized metal connector. The resilient plastic cover 20 wraps around the metal connector to allow its installation while the high voltage wire 22 is secured by the metal connector. The wire 22 has an insulating coating. The transformer 24 is supported by a grounded utility pole 26.

Applicant was informed of a problem with a high voltage transformer used in the field. The transformer had a large bird's nest built on it with twigs directly contacting a one-piece plastic cover (similar to the cover 20 in FIG. 3) over the metal connector of the bushing. The plastic cover was melted and charred where the twigs contacted the plastic cover. As a result, the energized connector was exposed. The Applicant came to the nonobvious conclusion that the twigs became somewhat conductive due to moisture, and a voltage arc or a low, prolonged leakage (shorting) current was conducted between the metal connector, the plastic cover, the twigs, and either the grounded transformer housing or another phase. Although the plastic cover was an insulator, a voltage arc or leakage current passed through the cover between the twigs and the metal connector. Typically, the plastic cover is pushed down over the metal connector and may directly contact the top of the metal connector. So, there may or may not be an air gap between the twigs, the cover, and the metal connector. In any event, there is only a single dielectric layer between the energized metal connector and the twig contacting the outside of the plastic cover. In some cases, this may not be enough to prevent a voltage arc or a leakage current through the cover.

What is needed is an improvement to the prior art plastic bushing cover that will prevent the cover from being burned and melted due to prolonged contact with a wildlife structure, such as a bird's nest, where the nest creates a low resistance path between the cover and a grounded structure or another phase.

### SUMMARY

A dielectric (e.g., polymer) bushing cover, for use with high voltage components, is described that has at least two layers separated by an air gap. An inner layer is a polymer (e.g., silicone) inner connector cover that securely fits over the metal connector (e.g., a clamp) of the bushing. The inner connector cover may directly contact the energized metal connector and has an opening for receiving an energized wire. Over the inner connector cover is an outer barrier that is separated from the inner connector cover by an air gap. The outer barrier is securely supported by the top skirts of the ceramic bushing.

The inner connector cover is formed of a resilient polymer and, optionally, has a rear vertical slot to allow a wire to pass through while the wire is already connected to the metal connector of the bushing. The inner connector cover is then pushed vertically down over the metal connector to create a secure frictional fit over the metal connector. This may be performed with a hot stick to allow the wire to be energized during installation.

The outer barrier may be two shells that snap together around the inner connector cover, or it may have a bendable section that acts like a hinge for allowing the outer barrier to be closed around the inner connector cover. Alternatively, the outer barrier may be flexible enough to be opened to surround the inner connector cover, then latched closed. The outer barrier has an opening that closes around the wire.

The bottom section of the outer barrier has internal protrusions that enter between the top skirts of the bushing for a secure fit, in order to maintain an air gap between the outer barrier and the inner connector cover.

Assuming the bushing is used for a transformer in a grounded housing, the two dielectric layers surrounding the metal connector and the air gap formed by the outer barrier and the inner connector cover prevent any leakage current and voltage arc between a bird's nest contacting the outer barrier and the transformer housing. Therefore, the bushing cover does not burn or melt due to the nest. Similarly, the bushing cover also prevents leakage current or voltage arcs between phases.

In one embodiment, the inner connector cover and the outer barrier are specifically designed to work together. In another embodiment, the outer barrier may surround a conventional polymer bushing cover without directly contacting the conventional bushing cover. Other embodiments are envisioned.

### BRIEF DESCRIPTION OF THE DRAWINGS

FIG. 1 illustrates the top portion of a conventional bushing, showing a top metal connector for securing an energized wire.

FIG. 2 illustrates a conventional transformer having two bushings extending from the top of the grounded metal housing of the transformer. The transformer receives a high voltage input and outputs a household voltage.

FIG. 3 illustrates a prior art polymer cover for the metal connector of the bushing, where the polymer cover may directly contact the energized metal connector of the bushing.

FIG. 4 is a perspective view of a polymer inner connector cover, in accordance with one embodiment of the invention, where the inner connector cover has a vertical slot for receiving a wire, allowing the inner connector cover to be installed while the wire is connected to the metal connector of the bushing.

FIG. 5 is a perspective view of a polymer inner connector cover, in accordance with another embodiment of the invention, where the inner connector cover has a top opening for receiving a wire prior to the wire being connected to the connector.

FIG. 6 illustrates the inner connector cover of FIG. 5 in position to be pushed down over the metal connector.

FIG. 7 illustrates the inner connector cover of FIG. 6 after being pushed down over the metal, circular bottom portion of the metal connector until the bottom of the inner connector cover contacts the top skirt of the bushing for a secure fit.

FIG. 8 is a perspective view of the outer barrier having its front half removed to show how the inner connector cover is secured in place over the metal connector while there is an air gap between the outer barrier and the inner connector cover. FIG. 8 shows the outer barrier's internal protrusion that enters between the top two skirts of the bushing to secure the outer barrier in place.

FIG. 9 is a side view of the outer barrier, surrounding the inner connector cover, installed over a bushing.

FIG. 10 illustrates the inside surface of the outer barrier when opened up, showing molded protrusions near the bottom that enter between the bushing's top two skirts for securing the outer barrier in place when the outer barrier is closed.

FIG. 11 illustrates the outer surface of the outer barrier when opened up.

FIG. 12 is a schematic illustration of the bushing cover of the present invention installed on two bushings of a transformer supported by a grounded utility structure.

FIG. 13 illustrates a semi-transparent modified inner cover for a bushing having a handwheel nut for tightening a clamp on a cable.

FIG. 14 illustrates the bushing and cover of FIG. 13.

FIG. 15 is a perspective side view of the bushing cover of FIGS. 13 and 14.

FIG. 16 is a perspective front view of the bushing cover of FIGS. 13 and 14.

FIG. 17 is a front view of an outer barrier for the hand wheel embodiments of FIGS. 13-16.

Elements labeled with the same numerals in the various figures may be identical or similar.

### DETAILED DESCRIPTION

A bushing cover is described having an inner connector cover and an outer barrier, where there is an air gap between the outer barrier and the inner cover.

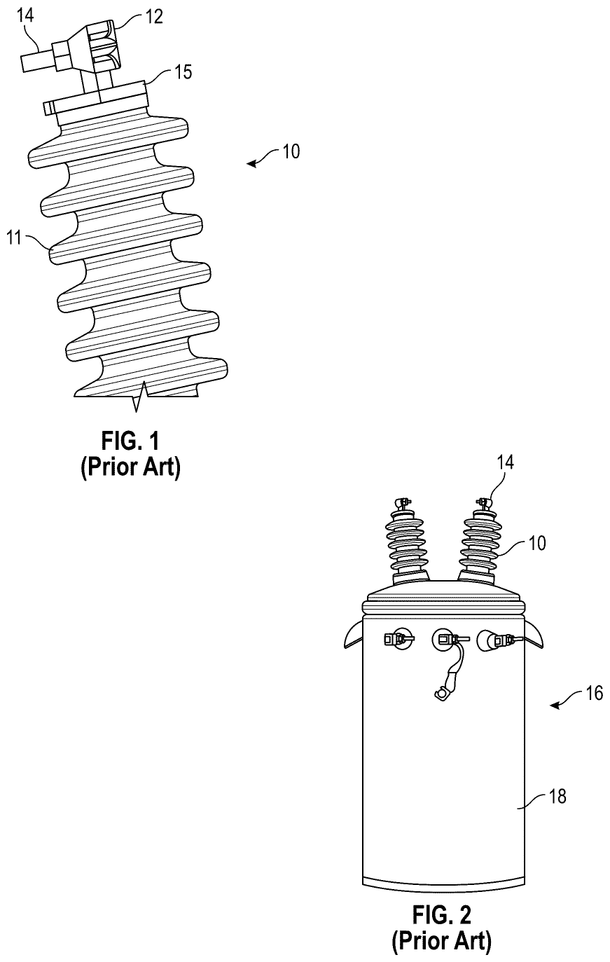

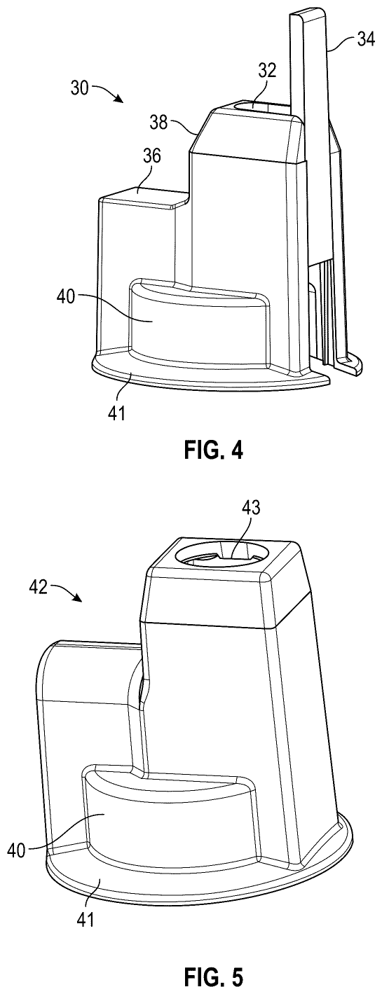

FIG. 4 is a perspective view of a resilient, molded polymer inner connector cover 30, in accordance with one embodiment of the invention. The inner connector cover 30 fits over the metal connector 12 (FIG. 1) of a conventional bushing while the wire is attached to the connector 12. A vertical slot 32 receives the wire, and the inner connector cover 30 is then slid down over the connector 12. A back plate 34 slides down in a groove to block the slot 32.

A first portion 36 of the inner connector cover 30 fits over the “tightening” screw 14 portion (FIG. 1) of the connector 12, a second portion 38 of the inner connector cover 30 fits over the wire attachment portion of the connector 12. The bottom rounded portion 40 fits securely over the metal, circular bottom portion 15 (FIG. 1) of the connector 12. A flange 41 sits on the top skirt of the bushing, so the inner connector cover 30 stays securely in place over the connector 12.

FIG. 5 is similar to FIG. 4 except the inner connector cover 42 has a top opening 43 to receive a wire prior to the wire being attached to the metal connector 12.

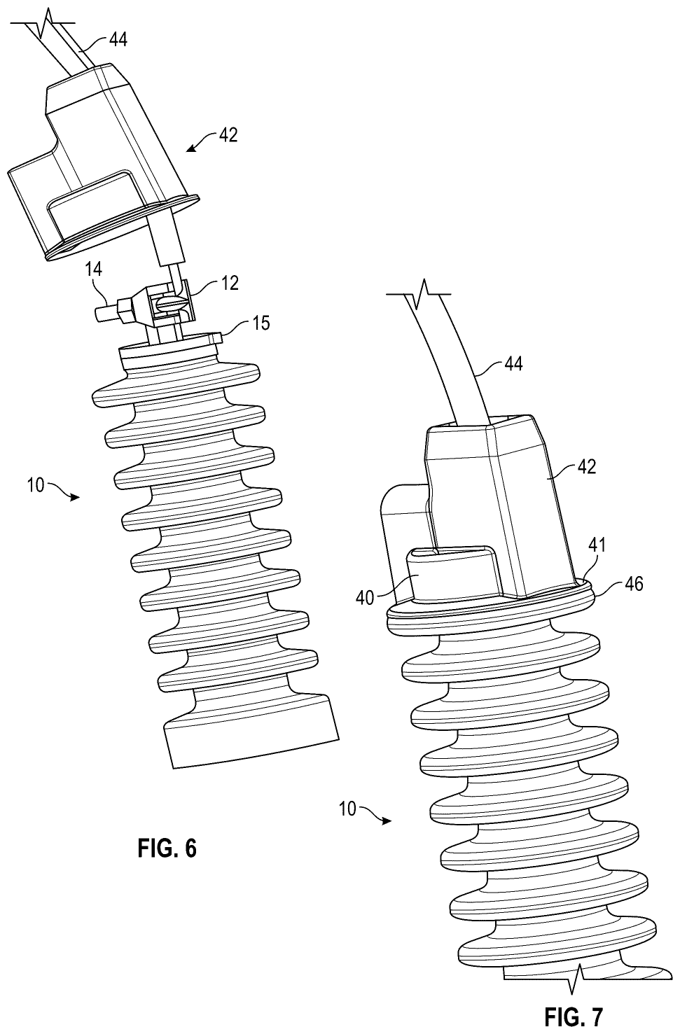

FIG. 6 illustrates the inner connector cover 42 of FIG. 5, having a wire 44 through its top opening, in position to be pushed down over the metal connector 12.

FIG. 7 illustrates the inner connector cover 42 of FIG. 6 after the bottom rounded portion 40 of the inner connector cover 42 is pushed down over the metal, circular bottom portion 15 of the metal connector 12 until the flange 41 contacts the top skirt 46 of the bushing 10 for a secure fit.

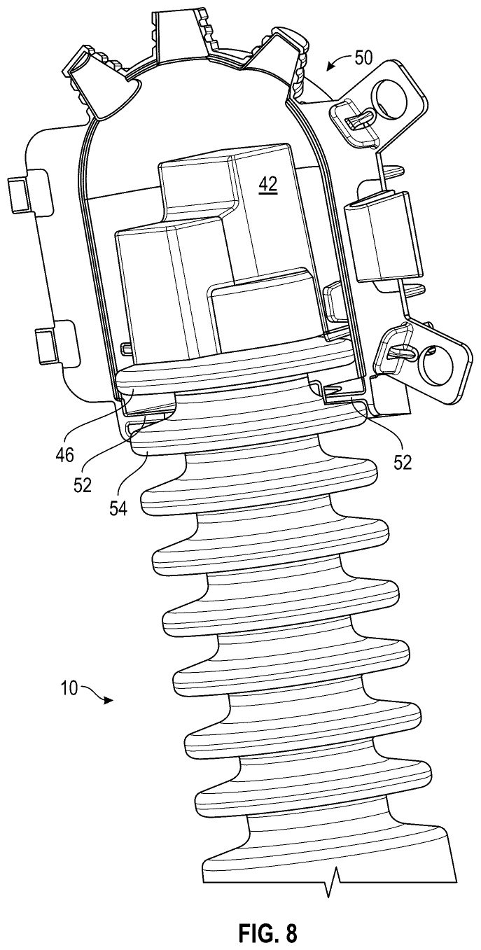

FIG. 8 illustrates an outer barrier 50 having its front half removed to show how the inner connector cover 42 is secured in place over the metal connector 12 (FIG. 1) while there is an air gap between the outer barrier 50 and the inner connector cover 42. FIG. 8 shows the outer barrier's internal protrusion 52 that enters between the top two skirts 46 and 54 of the bushing 10 to secure the outer barrier 50 in place.

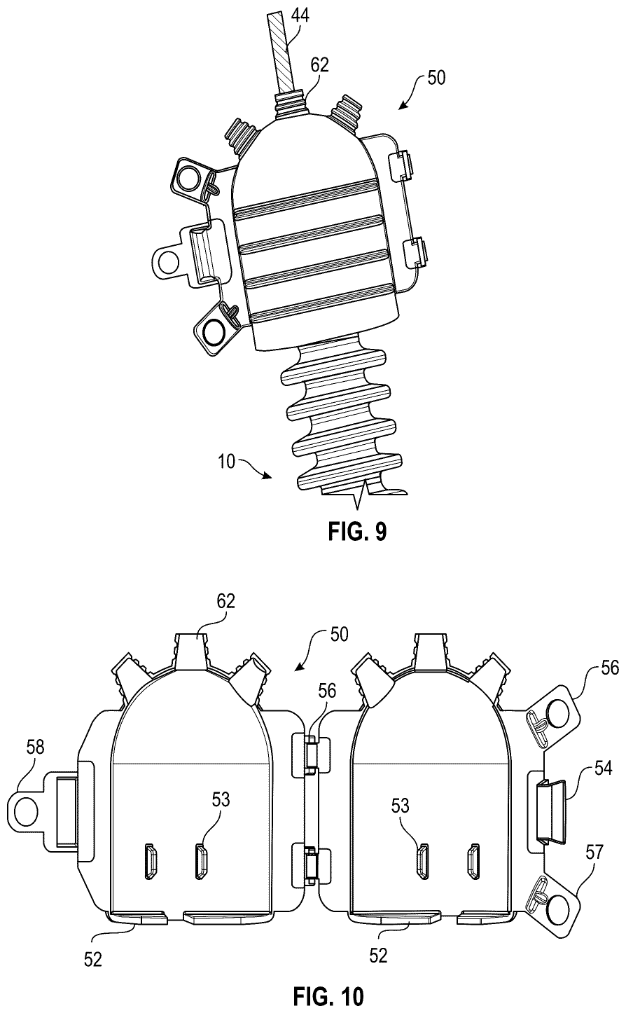

FIG. 9 illustrates the completed outer barrier 50 installed over the bushing 10 with the inner connector cover 42 within the outer barrier 50. The outer barrier 50 and inner connector cover 42 provide two layers of a dielectric and an air gap between a bird's nest (or other wildlife structure) contacting the outer barrier 50 and the metal connector 12. The breakdown voltage of the dielectric is much higher than that of air.

FIG. 10 illustrates the inside surface of the outer barrier 50 when opened up, showing molded internal protrusions 52 near the bottom that enter between the bushing's top two skirts for securing the outer barrier 50 in place when the outer barrier 50 is closed. The tabs 53 limit the downward movement of the outer barrier 50 over the bushing to ensure the internal protrusions 52 enter only between the top two skirts of the bushing.

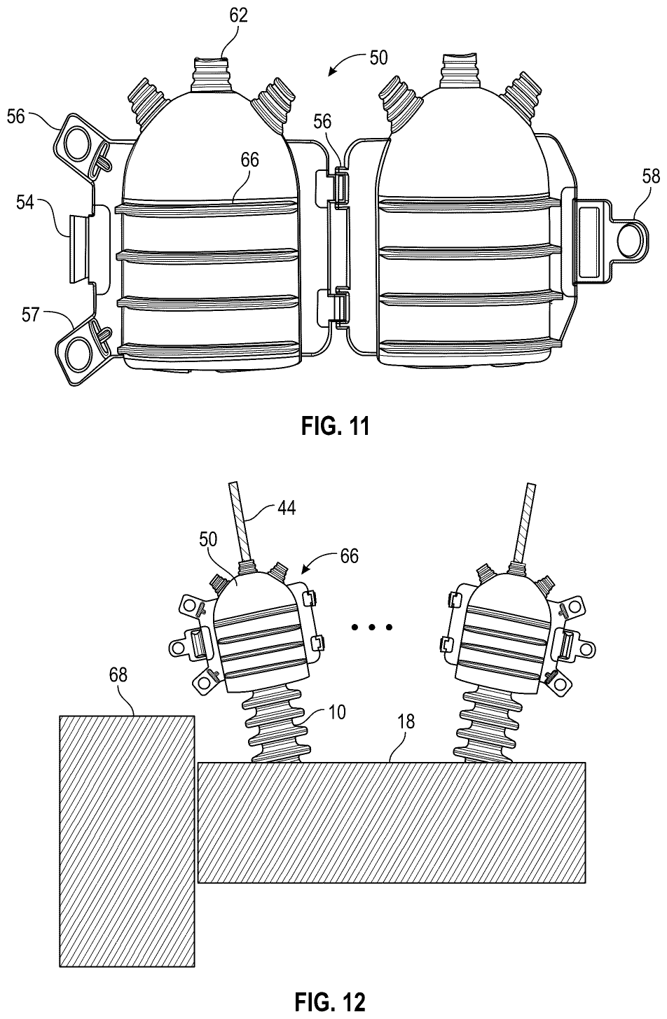

FIG. 11 illustrates the outer surface of the outer barrier 50 when opened up.

The outer barrier 50 may be two interconnecting shells that clamp together around the wire 44 and inner connector cover 42, using resilient latches 54 (or other securing devices), without directly touching the inner connector cover 42. The outer barrier 50 may have a hinged portion 56 so as to be opened like a clam shell for installation and then clamped shut using the molded latch 54. The hinged portion 56 is not required if the outer barrier 50 is sufficiently flexible along the boundary of the two halves. The latch 54 can be actuated by one or more hot sticks engaging holes 56, 57, and 58.

The outer barrier 50 also has one or more top openings 62 that clamp over the wire 44 to further secure the outer barrier 50 in position. There are various locations of openings 62 to receive a wire 44 at a variety of angles. Each half of the outer barrier 50 forms one half of each opening 62 so the outer barrier 50 can be installed while the wire 44 is attached to the bushing.

The outer barrier 50 includes rings 66 that protrude from the outer surface of the outer barrier 50 for preventing a continuous water path along the sides of the outer barrier 50. The rings 66 also increase the surface leakage distance along the outer barrier 50.

FIG. 12 is a schematic illustration of the multi-piece bushing cover 66 of the present invention installed on two bushings 10 of a transformer 18 supported by a grounded utility structure 68. Any bird's nest (having a certain electrical resistance) erected on the transformer 18 that touches the outer barrier 50 and the grounded transformer housing will not result in leakage current or a voltage arc due to the two dielectric layers surrounding the metal connector and the air gap between the nest and the energized metal connector. Therefore, there is no possibility of any voltage arc or leakage current burning and melting the bushing cover 66.

The outer barrier 50 may be used with a variety of existing conventional bushing covers if the outer barrier 50 can be installed with an air gap between an inner bushing cover and the outer barrier 50.

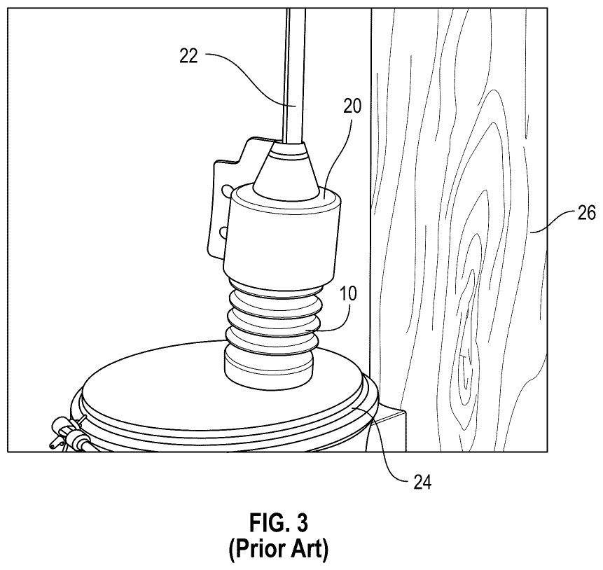

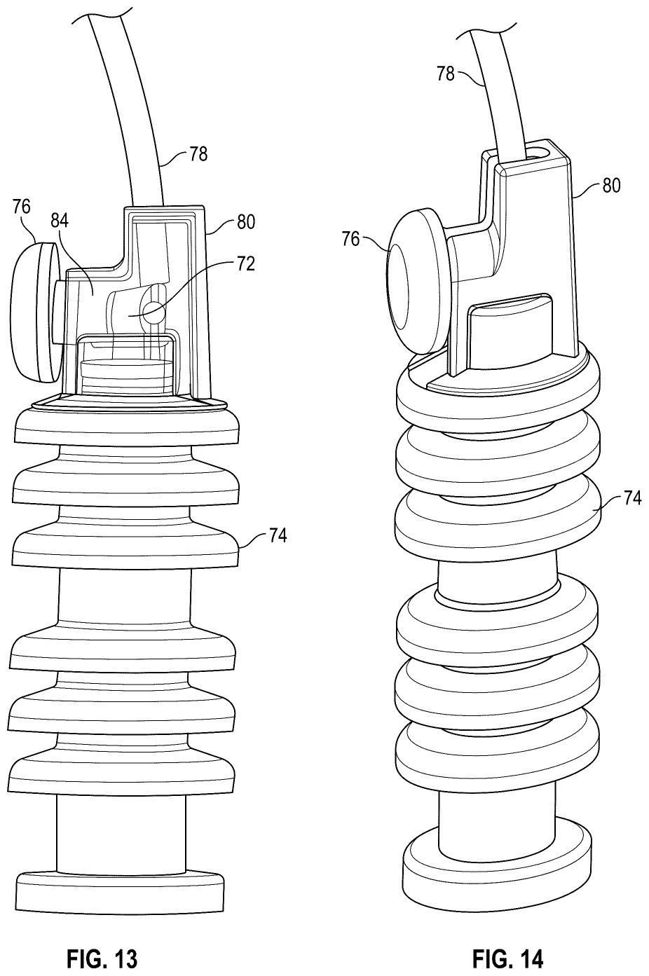

The covers of FIGS. 4-7 are suitable for bushings having clamps similar to that shown in FIGS. 1 and 2. Another type of conventional cable clamp for a bushing is shown in FIG. 13. The metal clamp 72 is connected to a conductor (not shown) internal to the ceramic bushing 74, and the conductor terminates at a transformer terminal inside a grounded housing or terminates at any other suitable high voltage equipment. The covers of FIGS. 4-7 could not fit over the handwheel knob 76, which has internal threads and acts like a nut to tighten the clamp 72 onto the cable 78. Therefore, the lineman does not need a tool to tighten the clamp.

FIG. 13 shows a new inner cover 80 in semi-transparency, and FIG. 14 shows the dielectric cover 80 opaque. An outer cover that fits over the inner cover 80 may be that shown in FIGS. 8-12.

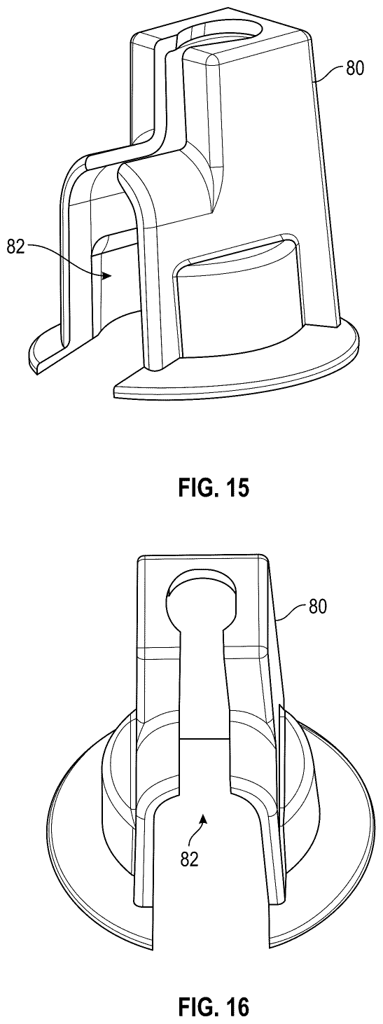

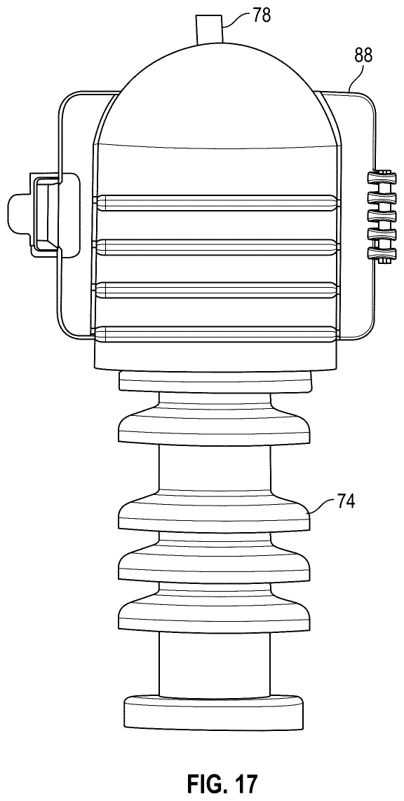

FIG. 15 is a perspective view of the cover 80, and FIG. 16 is a perspective front view of the cover 80. In the cover 30 of FIG. 4, there is a vertical slot in the cover for receiving the cable, and the cover 30 is then moved down over the metal clamp connector 12 of the bushing as shown in FIG. 6. Such a cover 30 could not be pushed over the handwheel knob 76 of FIGS. 13 and 14.

The cover 80 of FIGS. 15 and 16 has a vertical slot in the side opposite to the slot of the cover 30 of FIG. 4. This slot 82 allows the lineman to place the cover 80 around the energized cable 78, then slide the cover 80 down so that the bottom abuts the top of the ceramic insulator 74. Therefore, the slot 82 in the cover 80 allows the cover 80 to slide down over the narrow end portion 84 (FIG. 13) of the plastic handwheel but not over the handwheel knob 76. The slot is not needed if the wire is pushed through the top hole and then clamped to the metal connector.

The cover 80 may be used without the outer cover of FIGS. 8-12; however, the outer cover ensures that there are two dielectric layers and an air gap between any “grounded” nest contacting the outer cover and an energized part of the bushing.

FIG. 17 illustrates another clamshell outer barrier 88 for the hand wheel embodiments of FIGS. 13-16, where there is only one top opening for the wire 78.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is claimed is:

1. A bushing cover for a bushing configured for use with high voltage equipment, the bushing having an insulating portion and a metal connector for attachment to a wire, the bushing cover comprising:
a dielectric inner connector cover that fits over the metal connector; and
a dielectric outer barrier that, when installed on the bushing, is configured to surround the inner connector cover and secure to the insulating portion of the bushing, such that there are at least two dielectric layers between the metal connector and any structure contacting an outer surface of the outer barrier, the outer barrier having an opening for the wire to extend through the outer barrier.

2. The bushing cover of claim 1 wherein the inner connector cover has a slot for receiving the wire while the wire is attached to the metal connector.

3. The bushing cover of claim 1 wherein the outer barrier comprises two portions that secure around the insulating portion of the bushing.

4. The bushing cover of claim 1 wherein the inner connector cover is installed over the metal connector, and where the outer barrier is installed over the inner connector cover with an air gap between the inner connector cover and the outer barrier.

5. The bushing cover of claim 1 where the outer barrier comprises two portions that are latched together after installation over the inner connector cover.

6. The bushing cover of claim 1 where the inner connection cover and outer barrier are secured over the bushing, and the bushing is connected to a grounded housing of high voltage equipment.

7. The bushing cover of claim 6 where the equipment comprises a transformer.

8. The bushing cover of claim 1 where a bottom portion of the inner connector cover fits over a bottom portion of the metal connector.

9. The bushing cover of claim 1 wherein the insulating portion of the bushing includes skirts, wherein the outer barrier has an internal protrusion that enters between adjacent skirts on the bushing for securing the outer barrier in position over the bushing.

10. The bushing cover of claim 1 wherein the outer barrier comprises two portions that are connected by at least one hinge, and a securing device for securing the two portions together for installation over the bushing.

11. The bushing cover of claim 1 wherein the outer barrier has multiple openings for the wire to extend through, depending on an angle of the wire.

12. The bushing cover of claim 1 wherein the outer barrier is configured to be installed over the inner connector cover while the wire is connected to the metal connector of the bushing.

13. The bushing cover of claim 1 wherein the inner connector cover is specifically designed for use with the outer barrier.

14. The bushing cover of claim 1 wherein the inner connector cover is a conventional cover for a bushing.

15. The bushing cover of claim 1 wherein the metal connector comprises a clamp.

16. A method for insulating energized portions of a bushing, the bushing having an insulating portion and a metal connector, the metal connector for attaching to a wire, the method comprising:
providing a bushing cover, the bushing cover comprising a dielectric inner connector cover and a dielectric outer barrier;
installing the inner connector cover over the metal connector; and
installing the outer barrier over the inner connector cover so that at least two dielectric layers surround the metal connector, the outer barrier having an opening for the wire.

17. The method of claim 16 wherein the outer barrier comprises two portions that secure around the insulating portion of the bushing.

18. The method of claim 16 wherein the bushing has skirts, and wherein the outer barrier has an internal protrusion that enters between adjacent skirts on the bushing for securing the outer barrier in position over the bushing.

19. The method of claim 16 where the outer barrier comprises two or more portions that are secured together during installation to allow the outer barrier to be installed over the inner connector cover while the wire is energized.

20. A bushing cover for a bushing configured for use with high voltage equipment, the bushing having an insulating portion and a metal connector for attachment to a wire, the metal connector comprising a clamp being controlled by a handwheel having a knob for turning by a lineman, the bushing cover comprising:
a dielectric cover that fits over the metal connector, the cover having a slot for receiving the wire connected to the clamp, the slot being configured for also receiving a first portion of the handwheel so that the first portion is surrounded by the cover, the slot also being configured so that the knob is not surrounded by the cover to allow the lineman to turn the handwheel knob to control the clamp.
